(19) United States
(12) Patent Application Publication
(10) Pub. No.: US 2018/0191030 A1
(43) Pub. Date: Jul. 5, 2018

(54) LITHIUM-ION ELECTROCHEMICAL ACCUMULATOR WITH IMPROVED LEAK TIGHTNESS

(71) Applicant: Commissariat à l'énergie atomique et aux énergies alternatives, Paris (FR)

(72) Inventors: Marianne Chami, Fontaine (FR); Frédéric Dewulf, Voiron (FR)

(21) Appl. No.: 15/862,378

(22) Filed: Jan. 4, 2018

(30) Foreign Application Priority Data
Jan. 5, 2017 (FR) 17 50097

(51) Int. Cl. H01M 10/0565; H01M 10/0525; H01M 4/64; H01M 2/10

(52) U.S. Cl. CPC H01M 10/0565; H01M 10/0525; H01M 2004/028; H01M 2/1094; H01M 4/64

(57) ABSTRACT

The invention relates to a lithium-ion electrochemical accumulator—or Li-ion battery—having improved leak tightness of the liquid electrolyte contained therein. The architecture of the accumulator may be monopolar or bipolar. According to the invention, the sealing of the liquid electrolyte contained in the accumulator is improved through the presence of a leak-tight device or a plurality of leak-tight devices comprising a polymer that, in contact with the liquid electrolyte, converts to a gel in which the electrolyte is trapped and immobilised. Applications: any field in which Li-ion batteries of monopolar or bipolar architecture are likely to be used, and in particular in the manufacture of electric or hybrid vehicles and portable electronic devices (telephones, touchpads, computers, cameras, camcorders, etc).

### CROSS-REFERENCE TO RELATED APPLICATIONS

This application claims priority from French Patent Application No. 17 50097 filed on Jan. 5, 2017. The content of this application is incorporated herein by reference in its entirety.

### TECHNICAL FIELD

The invention relates to the field of lithium electrochemical accumulators operating along the principle of insertion-disinsertion, or in other words intercalation-deintercalation, of lithium in at least one electrode.

More specifically, the invention relates to a lithium-ion electrochemical accumulator more commonly known as a «Li-ion battery», having improved leak tightness of the liquid electrolyte contained therein.

This accumulator can be a Li-ion battery with monopolar architecture as well as a Li-ion battery with bipolar architecture.

The invention therefore finds application in all fields in which Li-ion batteries with monopolar or bipolar architecture are likely to be used, and in particular in the manufacture of electric or hybrid vehicles and portable electronic devices (telephones, touchpads, computers, cameras, camcorders, etc.).

### STATE OF THE ART

There are two categories of Li-ion batteries, namely:

Li-ion batteries with so-called «monopolar» architecture, which comprise only one electrochemical cell (an electrochemical cell being composed of a positive electrode and a negative electrode separated from one another by an electrolyte), this type of architecture essentially being obtained by winding or stacking; and;

Li-ion batteries with so-called «bipolar» architecture, which comprise a stack of several electrochemical cells separated from one another by a current collector in the form of a plate, a stack wherein one side of each current collector is in contact with the positive electrode of an electrochemical cell, whilst the other side of each current collector is in contact with the negative electrode of the adjacent electrochemical cell.

The architecture of a bipolar Li-ion battery therefore corresponds to the placing in series of several monopolar Li-ion batteries via current collectors—that are said to be «bipolar»—with the advantage, however, of having reduced electrical resistance compared with that of a system resulting from the mounting in series of monopolar Li-ion batteries by means of external connectors.

This bipolar architecture also allows limiting of battery weight and avoids useless volumes.

The main difficulty that designers of bipolar batteries come up against is that of obtaining perfect sealing of the electrolyte—which is liquid if the batteries are dedicated to high-power applications—between two adjacent electrochemical cells.

This sealing is of major importance since leakage of liquid electrolyte from one electrochemical cell to another may cause the onset of ionic short circuits, then leading to early dysfunction of the battery.

Typically, liquid electrolyte sealing is ensured by a seal made of a thermoset resin of epoxy resin type, or of an adhesive of acrylic adhesive type that is deposited around the periphery of the stack of electrochemical cells, as described for example in international application PCT WO 03/047021.

Other sealing solutions have been proposed such as:

adhering a soft, flexible adhesive film around the periphery of the bipolar current collectors (cf. U.S. Pat. No. 7,220,516);

providing the periphery of the bipolar current collectors with a fluorinated polymer barrier, lined with a leakproof seal in a polymer arranged on the outside of this barrier (cf. U.S. Pat. No. 7,097,937);

acting on the size of the bipolar current collectors so that the side walls of two adjacent electrochemical cells are offset crosswise from one another in relation to the stacking axis of these cells (cf. patent application EP 2 073 300); or still

forming the bipolar current collectors in the form of metal grids or metal foils housed in a strip in insulating material, the periphery of which has the function of forming a sealed area (cf. international PCT application WO 2011/157751).

In addition, it has been proposed to circumvent the use of a liquid electrolyte by replacing it with a gelled polymer electrolyte.

The use of a gelled polymer electrolyte is of interest in terms of sealing since this type of electrolyte has scarce flow, but it has the drawback of slowing the circulation of the lithium ions of the electrolyte between the positive and negative electrodes of the electrochemical cells. Yet, bipolar Li-ion batteries are batteries having low energy density and intended to operate with high power, which implies that the lithium ions of the electrolyte are able to circulate rapidly. The use of a gelled electrolyte therefore leads to lower performance.

The Inventors have therefore set out to propose a novel solution allowing further improvement in the leak tightness of a liquid electrolyte between two electrochemical cells of a bipolar Li-ion battery and thereby prevent any early dysfunction of this type of battery.

They additionally set themselves the objective that this solution should also allow improved leak tightness of the liquid electrolyte in a monopolar Li-ion battery, in particular of flexible package type.

They further set themselves the objective that this solution should be simple to implement, at a cost compatible with the industrial manufacture of Li-ion batteries, whether they be monopolar or bipolar.

### SUMMARY OF THE INVENTION

These objectives are reached with the invention which first proposes a lithium-ion electrochemical accumulator with a stacked monopolar architecture—more simply called a «monopolar Li-ion battery» in the remainder hereof—which comprises in a casing two current collectors between which an electrochemical cell is arranged, the electrochemical cell comprising a positive electrode, a negative electrode and a separator, the separator being intercalated between the positive electrode and the negative electrode and being impregnated with a liquid electrolyte comprising a lithium salt in solution in an organic solvent, in which:

the casing delimits a space with the two current collectors and with the electrochemical cell, the space surrounding the electrochemical cell and comprising a leak-tight device and a void zone;

the leak-tight device comprises a polymer that gels in contact with the solvent of the electrolyte, whereby the polymer increases in volume; and

the void zone is sized so that the void zone can subsequently be entirely filled with the polymer after gelling of the polymer.

Therefore, according to the invention, the liquid electrolyte seal of a stacked monopolar Li-ion battery is improved through the presence, in a space surrounding the electrochemical cell that this battery comprises, of a leak-tight device comprising a polymer which, in contact with the electrolyte or more specifically with the solvent of this electrolyte, is converted to a gel and hence into a stable three-dimensional network in which the electrolyte will be trapped and thereby immobilised.

Since the gelling of the polymer is accompanied by an increase in volume of this polymer, provision is also made in the invention to arrange, in the space surrounding the electrochemical cell of the battery, a void zone which is intended to allow the polymer to expand in volume without leading to stresses on the current collectors and/or on the electrochemical cell which could cause deformation of these elements and thereby harm both the structural and the functional integrity of the battery. The void zone will therefore be gradually filled with the polymer as and when it gels, until it is entirely filled by this polymer.

In the foregoing and in the remainder hereof:

by positive electrode is meant the electrode acting as cathode when the accumulator delivers current, i.e. when it is discharging, and acts as anode when the accumulator is charging; and

by negative electrode is meant the electrode which, conversely, acts as anode when the accumulator delivers current and acts as cathode when the accumulator is charging.

According to the invention, the leak-tight device preferably comprises at least one leak-tight frame surrounding a first part of the electrochemical cell, whilst the void zone surrounds a second part of the electrochemical cell.

In this case, it is particularly preferred that the leak-tight device comprises a first leak-tight frame surrounding the positive electrode of the electrochemical cell, and a second leak-tight frame surrounding the negative electrode of the electrochemical cell, and that the void zone surrounds the separator of the electrochemical cell.

As a variant however, it is possible to make provision so that the leak-tight device comprises a leak-tight frame surrounding the positive electrode, the negative electrode and the separator of the electrochemical cell, and that the void zone therefore surrounds this leak-tight frame.

In all cases, the space delimited by the casing with the two current collectors and the electrochemical cell preferably also comprises a sealing frame surrounding the leak-tight device and the void zone. In addition to forming an additional leak proof barrier against the liquid electrolyte, this sealing frame allows the structure of the battery to be rigidified and thereby takes part in maintaining the structural and functional integrity thereof.

The invention also proposes a lithium-ion electrochemical accumulator with bipolar architecture—more simply called «bipolar Li-ion battery» in the remainder hereof—which comprises in a casing two end current collectors between which a stack is arranged along an axis X of n electrochemical cells, n being an integer of at least 2, in which:

each electrochemical cell comprises a positive electrode, a negative electrode and a separator, the separator being intercalated between the positive electrode and the negative electrode and being impregnated with a liquid electrolyte comprising a lithium salt in solution in an organic solvent;

the n electrochemical cells are separated from one another by n−1 bipolar current collectors;

the casing delimits n spaces with the two end current collectors, the n−1 bipolar current collectors and the n electrochemical cells, each space of the n spaces surrounding an electrochemical cell and comprising a leak-tight device and a void zone;

the leak-tight device of each space of the n spaces comprises a polymer that gels in contact with the solvent of the electrolyte, whereby the polymer increases in volume; and

the void zone of each space of the n spaces is sized so that the void zone of each space of the n spaces can subsequently be entirely filled with the polymer after gelling of the polymer.

Therefore, according to the invention, the improvement in liquid electrolyte sealing between two adjacent electrochemical cells of a bipolar Li-ion battery is based on the same principle as above, namely the presence in each of the spaces surrounding the electrochemical cells of a leak-tight device comprising a polymer that will form a gel in contact with the liquid electrolyte, this leak-tight device here also being accompanied by a void zone able to allow the polymer to increase in volume without harming the structural and functional integrity of the battery.

In the foregoing and in the remainder hereof, by bipolar current collector is meant a current collector which separates two electrochemical cells from one another and which, on a first side, carries an electrode of one of these electrochemical cells, and on a second side opposite the first side carries an electrode of opposite sign of the other of these electrochemical cells.

In addition, it is considered that an electrochemical cell is adjacent to another electrochemical cell when it precedes or follows immediately after the latter in the stack and is therefore only separated therefrom by a bipolar current collector.

As previously, the leak-tight device of each space of the n spaces preferably comprises at least one leak-tight frame surrounding a first part of the electrochemical cell surrounded by this space, whereas the void zone surrounds a second part of the electrochemical cell surrounded by said space.

In this case, it is most particularly preferred that the leak-tight device should comprise a first leak-tight frame surrounding the positive electrode of the electrochemical cell, and a second leak-tight frame surrounding the negative electrode of the electrochemical cell, and that the void zone surrounds the separator of the electrochemical cell.

As a variant however, it is possible here also to make provision for the leak-tight device of each space of the n spaces to comprise a leak-tight frame that surrounds the positive electrode, the negative electrode and the separator of the electrochemical cell surrounded by this space, and that the void zone then surrounds this leak-tight frame.

Preferably the n−1 bipolar current collectors extend, from axis X outwardly from the battery, i.e. in a plane orthogonal to this axis, in line with the end current collectors. In other words, the n−1 bipolar current collectors have the same size as the end current collectors in a plane orthogonal to axis X and therefore the same extent as the end current collectors in this plane.

In this case, each space of the n spaces preferably comprises a sealing frame which surrounds the leak-tight device and the void zone contained in this space, and which here too forms an additional liquid electrolyte sealing barrier allowing rigidification of the battery.

As a variant however, it is possible to make provision so that the n−1 bipolar current collectors extend from axis X outwardly from the accumulator, short of the two end current collectors. In other words, the n−1 bipolar current collectors have a size lower than the size of the end current collectors in a plane orthogonal to axis X and therefore an extent lower than the extent of the end current collectors in this plane.

In this case, the bipolar Li-ion battery preferably comprises a single sealing frame which extends from one end current collector to the other end current collector and which surrounds the n spaces and the n−1 bipolar current collectors.

The number n of electrochemical cells contained in the bipolar Li-ion battery is selected so as to obtain a satisfactory total voltage Utot as a function of the applications for which this battery is intended, in accordance with the rule Utot=n×Un, where Un corresponds to the voltage of the electrochemical pair used. Typically, n can be between 2 and 26 for the electrochemical pair lithium iron phosphate (or LFP)/lithium titanate (or LTO) having a nominal voltage Un of 1.9 V. Therefore, for n=26, the total voltage of the bipolar Li-ion battery is at least equal to 48 V (Utot=26×1.9 V≈49 V), which enables the bipolar Li-ion battery to meet applications in electric vehicles for example. For another electrochemical pair having a nominal voltage Un higher than that of the LFP/LTO pair, then the number n of electrochemical cells can be reduced to obtain the same total voltage.

Whether the Li-ion battery is monopolar or bipolar, the positive and negative electrodes of the electrochemical cell(s) can be composed of an electrode material capable of allowing intercalation/deintercalation of lithium ions, on the understanding that the negative electrode material must differ from the positive electrode material.

For example, the positive electrode can particularly be composed of an electrode material comprising:

at least one lithium oxide such as a lithium oxide comprising manganese of spinel structure, a lithium oxide of lamellar structure or a polyanion-based lithium oxide of formula LiM_{y}(XO_{z})ₙ where M is an element selected from among Mn, Fe, Co, Ni, Cu, Mg, Zn, V, Ca, Sr, Ba, Ti, Al, Si, B and Mo, X is an element selected from among P, Si, Ge, S and As, and y, z and n are positive integers, such as lithium iron phosphate (LiFePO₄ or LFP) or lithium cobalt phosphate (LiCoPO₄ or LCP);

a polymer or copolymer acting as binder, such as a fluorinated polymer of poly(vinylidene fluoride) type (or PVdF), a fluorinated copolymer of poly(vinylidene fluoride-co-hexafluoropropylene) (or PVdF-HFP) or a mixture thereof; and optionally:

an electronic conductive additive, such as particles of carbon black, carbon fibres or a mixture thereof.

The negative electrode can particularly be composed of an electrode material comprising:

a lithium titanium oxide such as an oxide of formula Li₍₄₋ₓ₎MₓTi₅O₁₂ or Li₄M_{y}Ti_{(5-y)}O₁₂ where x and y range from 0 to 0.2, M being an element selected from among Na, K, Mg, Nb, Al, Ni, Co, Zr, Cr, Mn, Fe, Cu, Zn, Si and Mo, a non-lithium titanium oxide such as TiO₂, an oxide of formula M_{y}Ti_{(5-y)}O₁₂ where y ranges from 0 to 0.2 and M is an element selected from among Na, K, Mg, Nb, Al, Ni, Co, Zr, Cr, Mn, Fe, Cu, Zn, Si and Mo, or a carbon material such as graphite;

a polymer or copolymer acting as binder of the type among those previously mentioned; and optionally

an electronic conductive additive of the type among those previously mentioned.

Preferably, the positive electrode is composed of an electrode material comprising lithium iron phosphate LiFePO₄ whilst the negative electrode is composed of an electrode material comprising lithium titanate Li₄Ti₅O₁₂ (or LTO).

Also preferably, these electrodes are of «dry» type, i.e. non-gelled, to guarantee optimal high-power functioning of the Li-ion battery.

The liquid electrolyte may be any electrolyte comprising a lithium salt in solution in an organic solvent.

For example, the lithium salt may particularly be selected from among lithium hexafluorophosphate (LiPF₆), lithium perchlorate (LiClO₄), lithium tetra-fluoroborate (LiBF₄), lithium hexafluoroarsenate (LiAsF₆), lithium trifluoromethane-sulfonate (LiCF₃SO₃), lithium bis(trifluoromethylsulfonyl)imide (LiN(CF₃SO₂)₂ or LiTFSI), lithium bis(perfluoroethylsulfonyl)imide (LiN(C₂F₅SO₂)₂ or LiBETI) and mixtures thereof, whilst the organic solvent may particularly be selected from among carbonates such as ethylene carbonate (or EC), propylene carbonate (or PC), dimethyl carbonate (or DMC), diethyl carbonate (or DEC) or methylethyl carbonate (MEC), ethers such as dimethoxyethane, dioxolane, dioxane or tetraethyleneglycol dimethylether (or TEGDME), alkylphthalates such as dimethylphthalate (DMP) or diethylphthalate (DEP), dimethylformamide (or DMF), glycolsulfite, γ-butyrolactone and mixtures thereof.

Preferably the lithium salt is lithium hexafluorophosphate LiPF₆, whilst the organic solvent is a carbonate or mixture of carbonates, typically an EC/PC mixture.

Also preferably, the liquid electrolyte impregnates a separator formed of a porous material and arranged between the positive electrode and the negative electrode of the electrochemical cell.

This separator may be in any material able to receive a liquid electrolyte in its porosity that is chemically inert against the active materials of the electrodes. For example, the separator may particularly be in a porous polymer such as a polyolefin or mixture of polyolefins (polyethylene and/or polypropylene), a poly(ethylene oxide) (or PEO), a polyacrylonitrile (or PAN), a PVdF, a PVdF-HFP or a mixture thereof.

The current collectors, whether end or bipolar, may be single-layer in which case they are preferably composed of an aluminium, copper or aluminium plate, or else bilayer in which case they are preferably composed of an aluminium plate coated with a copper layer. For example, they have a thickness of 20 μm.

According to the invention, the polymer that gels in contact with the organic solvent of the electrolyte—more simply called «gelling polymer» in the remainder hereof—may particularly be any of the polymers proposed in the prior art to prepare gelled polymer electrolytes, or a mixture thereof.

Therefore, these may be a PEO, a PAN, a PVdF, a PVdF-HFP, a poly(vinyl chloride) (or PVC), a poly(vinylidene carbonate) (or (PVdC), a poly(p-phenylene terephthalamide) (or PPTA), a polyvinylsulfone (or PVS), a polyvinylpyrrolidone (or PVP), a poly(methylmethacrylate) (or PMMA), an ethylene glycol dimethacrylate (or EGDMA) or a mixture thereof.

In this respect, the reader may refer to Chapter 3 (M. Alamgir and K. M. Abraham) of the publication Lithium batteries: New materials, Developments and Perspectives edited by G. Pistoia, Elsevier 1994, in which a certain number of polymers that have been proposed for use in the preparation of gelled polymer electrolytes are presented.

Among the aforementioned gelling polymers, preference is given to a polymer selected from among PEOs, PANs, PVdFs, PVdF-HFPs and mixtures thereof.

When manufacturing the Li-ion battery, the gelling polymer can be added to this battery either in the «dry» state, or in an already partly gelled state.

The sealing frame(s) are preferably in an electrical insulating material which may be a double-sided adhesive material, for example a double-sided acrylic with a core in polypropylene (or PP), poly(ethylene terephthalate) (or PET) or polyurethane (or PU), or else a thermoset resin such as an epoxy resin.

With regard to the casing, this may be flexible (in which case it is made of a laminated film for example having an aluminium foil web coated on its outer surface with a PET or polyamide layer and coated on its inner surface with a PP or PE layer), or else it may be rigid (in which case it may be in a lightweight, low-cost metal for example such as stainless steel, aluminium or titanium, or else in a thermoset resin such as an epoxy resin) depending on the intended type of application.

Whether monopolar or bipolar, the Li-ion battery of the invention can be produced using techniques to deposit materials in the form of layers, followed by assembling of the layers, that are usually used to manufacture monopolar or bipolar Li-ion batteries.

Therefore, in particular:

the positive and negative electrodes can be prepared by depositing electrode materials on the current collectors using the technique known as «slot-die coating», followed by hot calendaring, typically at 80° C. to impart porosity thereto;

the leak-tight frames can be formed by printing techniques (screen printing, flexography, . . . );

the sealing frames can be formed using printing techniques (screen printing, flexography, . . . ); as a variant they may be double-sided adhesive tapes deposited on the current collectors; whilst

the casing can be formed by heat sealing for flexible casing, or by laser welding for rigid casing.

### BRIEF DESCRIPTION OF THE FIGURES

Other advantages and characteristics of the invention will become apparent from the following additional, detailed description given to illustrate the invention and referring to the appended Figures in which:

FIGS. 1A and 1B are schematic longitudinal-section views of an example of a monopolar Li-ion battery according to the invention, at two different stages: FIG. 1A showing this battery such as it appears just after manufacture, and FIG. 1B showing this battery after an operating time of several weeks;

FIGS. 2A and 2B are schematic views similar to FIG. 1A and 1B but for a first variant of embodiment of the monopolar Li-ion battery of the invention;

FIGS. 3A and 3B are schematic views similar to FIGS. 1A and 1B but for a second variant of embodiment of the monopolar Li-ion battery of the invention;

FIGS. 4A and 4B are schematic views similar to FIGS. 1A and 1B but for a third variant of embodiment of the monopolar Li-ion battery of the invention;

FIGS. 5A and 5B are schematic longitudinal-section views of an example of a bipolar Li-ion battery of the invention at two different stages: FIG. 5A showing this battery such as it appears just after manufacture, and FIG. 5B showing this battery after an operating time of several weeks;

FIGS. 6A and 6B are schematic views similar to FIGS. 5A and 5B but for a variant of embodiment of the bipolar Li-ion battery of the invention.

In these Figures, the same references are used to designate the same elements.

In addition and for reasons of clarity, the dimensions of the different elements illustrated in these Figures are not in proportion with their true dimensions.

### DETAILED DESCRIPTION OF PARTICULAR EMBODIMENTS

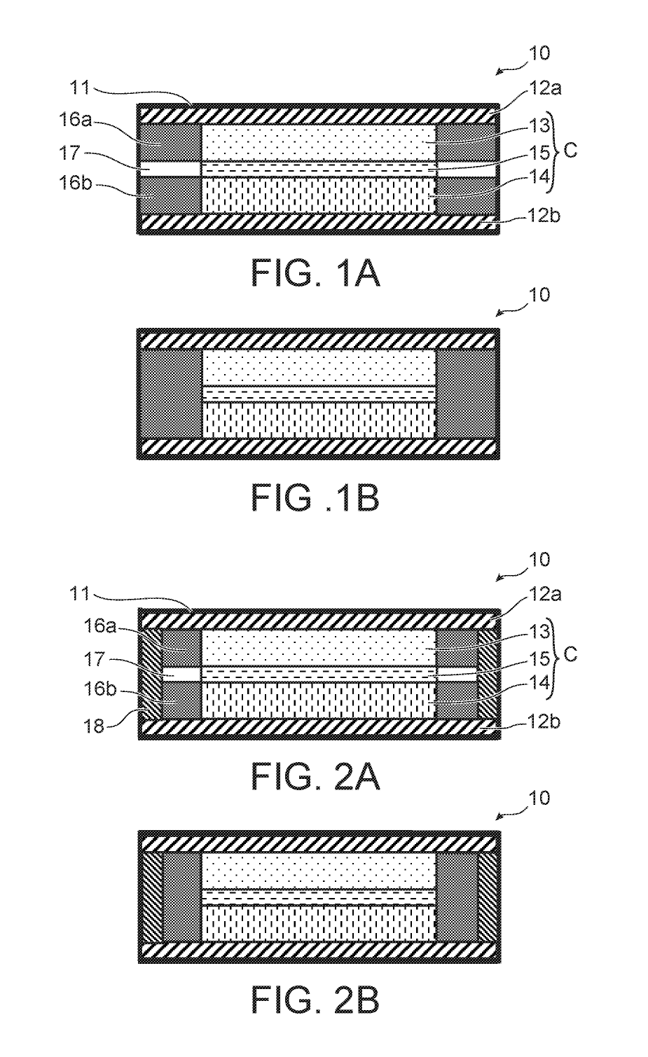

Reference is first made to FIG. 1A which schematically illustrates a longitudinal-section view of an example of a monopolar Li-ion battery of the invention such as it appears just after manufacture.

As can be seen in this Figure, the battery referenced 10 comprises in a casing 11 that may be flexible or rigid two current collectors 12ₐ and 12_{b}, for example in aluminium, between which an electrochemical cell C is arranged.

This electrochemical cell comprises a positive electrode 13, for example in LiFePO₄, in contact with the current collector 12ₐ, and a negative electrode 14, for example in LTO, in contact with the current collector 12_{b}.

It additionally comprises a separator 15, for example in a polyolefin or mixture of polyolefins (PE and/or PP), which is impregnated with a liquid electrolyte comprising a lithium salt, for example LiPF₆, in solution in an organic solvent, for example an EC/PC mixture, and which is intercalated between the positive electrode 13 and the negative electrode 14 while being in contact with these electrodes.

According to the invention, a space is delimited by the casing 11 with the current collectors 12ₐ and 12_{b} on the one hand, and with the cell C on the other hand, which space surrounds this cell and houses a leak-tight device 16 and a void zone 17, i.e. a zone free of any material.

In the battery shown in FIG. 1A, the leak-tight device 16 is composed of a first leak-tight frame 16ₐ surrounding the positive electrode 13 of the cell C and a second leak-tight frame 16_{b} surrounding the negative electrode 14 of the cell C.

The void zone 17 surrounds the separator 15 so that this void zone is intercalated between the two leak-tight frames 16ₐ and 16_{b}.

Each of the leak-tight frames 16ₐ and 16_{b} comprises a gelling polymer that will ensure leak-proofing of the battery by forming a gel in contact with the solvent of the liquid electrolyte which may escape from the separator, and will therefore form a stable three-dimensional network in which this electrolyte will be trapped and thereby immobilised. For example, this polymer is a PEO, a PAN, a PVdF or a PVdF-HFP.

The conversion of the polymer to a gel being accompanied by an increase in the volume of this polymer, the void zone 17 is designed to allow the two leak-tight frames 16ₐ and 16_{b} to increase in volume without this increase in volume translating as the application of stresses to the current collectors 12ₐ and 12_{b} and cell C, such stresses being likely to cause deformation of these collectors and this cell.

The void zone 17 will therefore be gradually filled with the polymer via confluence of the two leak-tight frames 16ₐ and 16_{b} as and when this polymer gels until it is entirely filled with this polymer as illustrated in FIG. 1B giving a view of the battery 10 that is similar to the view in FIG. 1A but after entire filling of the void zone 17 by the polymer.

Reference is now made to FIGS. 2A and 2B giving schematic views similar to those in FIGS. 1A and 1B but for a first variant of embodiment of the battery 10, FIG. 2A showing this battery as it appears just after manufacture and FIG. 2B showing this battery after entire filling of the void zone 17 by the polymer.

In this first variant of embodiment, the battery 10 only differs from the one illustrated in FIGS. 1A and 1B in that the space delimited by the casing with the current collectors 12ₐ and 12_{b} on the one hand, and cell C on the other hand, further comprises a sealing frame 18 which surrounds both the two leak-tight frames 16ₐ and 16_{b} and the void zone 17, which not only reinforces the leak-tight of the battery electrolyte but also guarantees that the distance separating the current collectors 16ₐ and 16_{b} remains constant throughout the lifetime of the battery.

The sealing frame 18 therefore takes part in maintaining the structural and functional integrity of the battery.

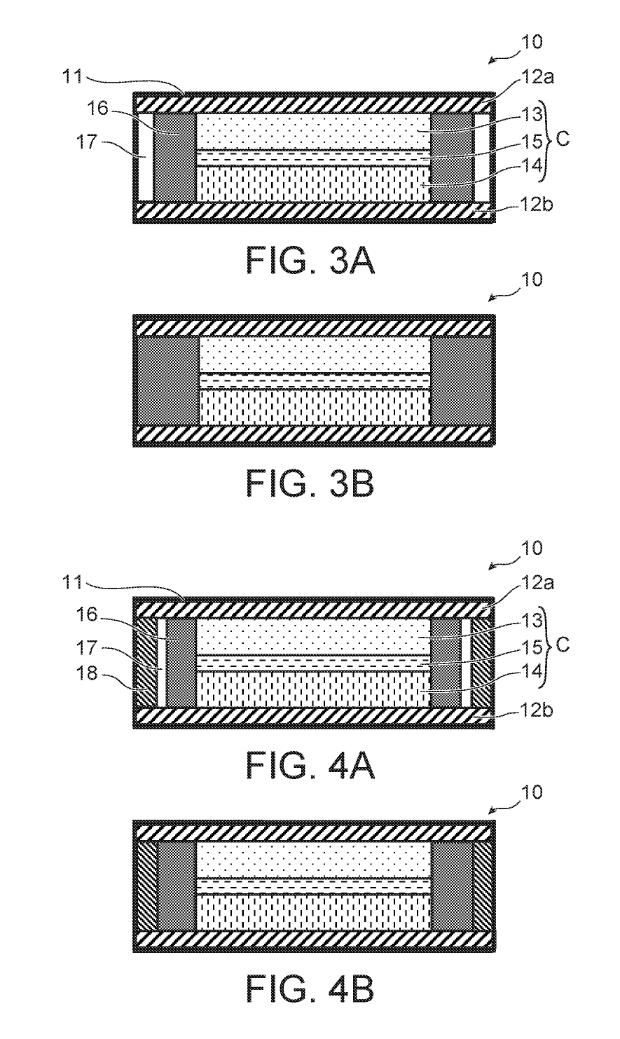

Schematic views similar to FIGS. 1A and 1B but for a second variant of embodiment for manufacturing the battery 10 are illustrated in FIGS. 3A and 3B, FIG. 3A showing this battery as it appears just after manufacture and FIG. 3B showing this battery after entire filling of the void zone 17 by the polymer.

In this second variant of embodiment, the battery 10 only differs from the one shown in FIGS. 1A and 1B first in that the leak-tight device 16 is only composed of a single leak-tight frame surrounding the positive electrode, the separator 15 and the negative electrode 14 of cell C, and secondly in that the void zone 17 surrounds this leak-tight device.

Therefore, in this second variant of embodiment, the void zone 17 will gradually be filled and then entirely filled with the polymer via expansion of the leak-tight device 16 outwardly from the battery.

Schematic views similar to FIGS. 1A and 1B but for a third variant of embodiment of the battery 10 are illustrated in FIGS. 4A and 4B, FIG. 4A showing this battery as it appears just after manufacture and FIG. 4B showing this battery after entire filling of the void zone 17 by the polymer.

In this third variant of embodiment, the battery 10 only differs from the one shown in FIGS. 3A and 3B in that the space delimited by the casing 11 with the current collectors 12ₐ and 12_{b} on the one hand, and with the cell C on the other hand, further comprises a sealing frame 18 surrounding the void zone 17.

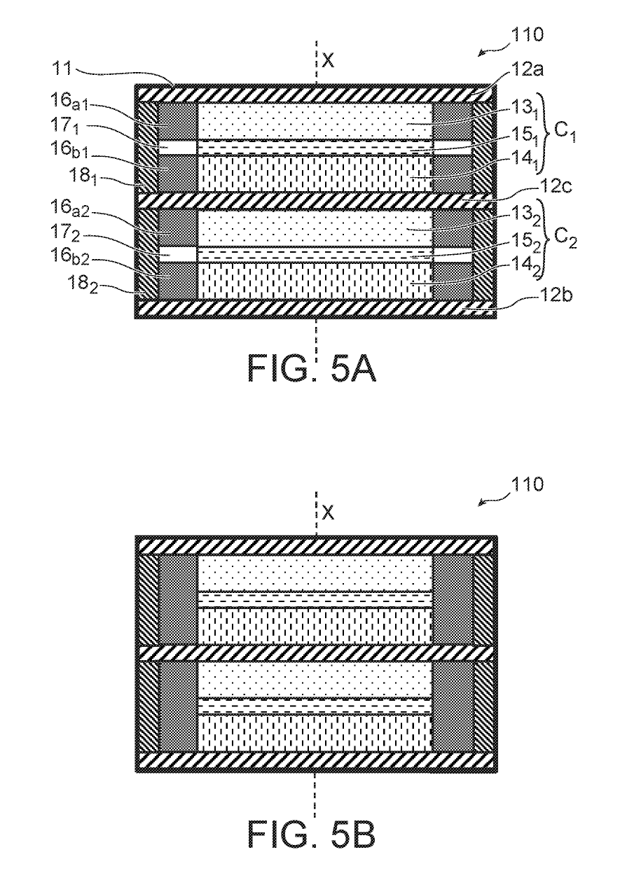

Reference is now made to FIG. 5A which schematically illustrates, in longitudinal-section, an example of a bipolar Li-ion battery of the invention such as it appears just after manufacture.

As can be seen in this Figure, the battery referenced 110 comprises in a casing 11 two current collectors 12ₐ and 12_{b} respectively, which are said to be «end» collectors since they are positioned at the two ends of the battery in the direction of axis X, between which there is arranged a stack of several electrochemical cells along axis X.

For the battery 10 shown in FIG. 5A, this stack only comprises two electrochemical cells C₁ and C₂ respectively to simplify the illustration thereof, but the stack could just as well comprise a higher number of electrochemical cells without any change to the architecture of the battery.

Each of the cells C₁ and C₂ comprises a positive electrode, respectively 13₁ and 13₂, for example in LiFePO₄, and a negative electrode respectively 14₁ and 14₂, for example in LTO. Each cell also comprises a separator, respectively 15₁ and 15₂, for example in a polyolefin or mixture of polyolefins (PE and/or PP), which is impregnated with a liquid electrolyte comprising a lithium salt, for example LiPF₆, in solution in an organic solvent, for example an EC/PC mixture, and which is intercalated between the positive and negative electrodes while being in contact with these electrodes.

The positive electrode 13₁ of cell C₁ is in contact with the end current collector 12ₐ whilst the negative electrode 14₂ of electrochemical cell C₂ is in contact with the end current collector 12_{b}.

The cells C₁ and C₂ are separated from one another by a third current collector 12_{c} that is said to be «bipolar» since it is both in contact with the negative electrode 14₂ of cell C₁ and with the positive electrode 13₁ of cell C₂.

This third current collector extends from axis X outwardly from the battery, i.e. in a plane orthogonal to axis X, in line with the current collectors 12ₐ and 12_{b}. In other words, the three current collectors 12ₐ, 12_{b} and 12_{c} have a same size in a plane orthogonal to axis X and extend similarly in this plane.

According to the invention, a first space is delimited by the casing 11 with the current collectors 12ₐ and 12_{c} on the one hand, and with the cell C₁ on the other hand, which first space surrounds this cell and houses a leak-tight device 16₁ and a void zone 17₁.

Similarly, a second space is delimited by the casing 11 with the current collectors 12_{c} and 12_{b} on the one hand, and with cell C₂ on the other hand, which second space surrounds this cell and houses a leak-tight device 16₂ and a void zone 17₂.

In the example illustrated in FIG. 5A—which corresponds to one particularly preferred embodiment of a bipolar Li-ion battery of the invention—each of the leak-tight devices 16₁ and 16₂ is composed of a first hermetic frame 16ₐ₁ and 16ₐ₂ respectively, one surrounding the positive electrode 13₁ of cell C₁ and the other surrounding the positive electrode 13₂ of cell C₂, and a second hermetic frame respectively 16_{b1} and 16_{b}, one surrounding the negative electrode 14₁ of cell C1 and the other surrounding the negative electrode 14₂ of cell C₂.

The void zones 17₁ and 17₂ surround the separators 15₁ and 15₂ respectively so that the void zone 17₁ is intercalated between the two leak-tight frames 16ₐ₁ and 16_{b1} whilst the void zone 17₂ is intercalated between the two leak-tight frames 16ₐ₂ and 16_{b2}.

The leak-tight frames 16ₐ₁, 16ₐ₂, 16_{b1} and 16_{b2} all comprise a gelling polymer. These leak-tight frames and the void zones 17₁ and 17₂ fulfil the same functions as those previously described for the leak-tight frames 16ₐ and 16_{b} and for the void zone 17 of the monopolar Li-ion battery shown in FIGS. 1A and 1B.

In the example illustrated in FIG. 5A, the space which is delimited by the casing 11 with the current collectors 12ₐ and 12_{c} on the one hand, and with cell C₁ on the other hand, further comprises a sealing frame 18₁ which surrounds both leak-tight frames 16ₐ₁ and 16_{b1} and the void zone 17₁.

Similarly, the space which is delimited by the casing 11 with the current collectors 12_{c} and 12_{b} on the one hand, and with cell C2 on the other hand, further comprises a sealing frame 18₂ which surrounds the two leak-tight frames 16ₐ₂ and 16_{b2} and the void zone 17₂.

Here again, the sealing frames 18₁ and 18₂ fulfil the same functions as those previously described for the sealing frame 18 of the monopolar Li-ion battery shown in FIGS. 2A and 2B.

The bipolar Li-ion battery after entire filling of the void zones 17₁ and 17₂ by the polymer is shown in FIG. 5B.

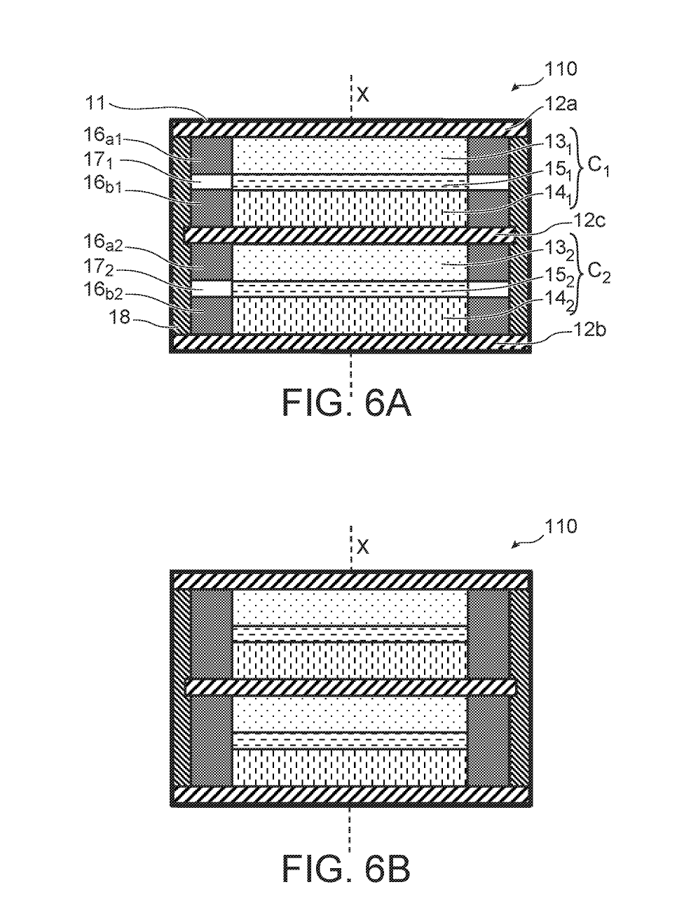

Wit reference now to FIGS. 6A and 6B giving similar schematic views to FIGS. 5A and 5B but for a variant of embodiment of the battery 110, FIG. 6A showing this battery such as it appears just after manufacture and FIG. 6B showing this battery after entire filling of the void zones 17₁ and 17₂ by the polymer.

In this variant of embodiment, the battery 110 differs from the one shown in FIG. 5A in that the bipolar current collector 12_{c} extends from axis X outwardly from the battery, short of the end current collectors 12ₐ and 12_{b}. In other words, the bipolar current collector 12_{c} has a size lower than the size of the end current collectors 12ₐ and 12_{b} in a plane orthogonal to axis X and therefore an extent lower than the extent of the end current collectors 12ₐ and 12_{b} in this plane.

On this account, the bipolar Li-ion battery only comprises one sealing frame 18 which extends from the current collector 12ₐ to current collector 12_{b} and surrounds the leak-tight frame 16ₐ₁, the void zone 17₁, the leak-tight frame 16_{b1}, the current collector 12_{c}, the leak-tight frame 16ₐ₂, the void zone 17₂ and the leak-tight frame 16_{b2}.

The invention is in no way limited to the embodiments just described. For example, and in particular, it is fully possible to apply the configuration of the leak-tight device/void zone shown in FIGS. 3A and 4A to the electrochemical cells of a bipolar Li-ion battery.

### CITED REFERENCES

[1] International application PCT WO 03/047021

[2] U.S. Pat. No. 7,220,516

[3] U.S. Pat. No. 7,097,937

[4] Patent application EP 2 073 300

[5] International application PCT WO 2011/157751

[6] M. Alamgir and K. M. Abraham, Lithium batteries: New materials, Developments and Perspectives, Chapter 3, published by G. Pistoia, Elsevier 1994

1. A lithium-ion electrochemical accumulator of stacked monopolar architecture comprising in a casing two current collectors between which an electrochemical cell is arranged, the electrochemical cell comprising a positive electrode, a negative electrode and a separator, the separator being intercalated between the positive electrode and the negative electrode and being impregnated with a liquid electrolyte comprising a lithium salt in solution in an organic solvent, in which:
the casing delimits a space with the two current collectors and with the electrochemical cell, the space surrounding the electrochemical cell and comprising a leak-tight device and a void zone;
the leak-tight device comprises a polymer that gels in contact with the solvent of the electrolyte, whereby the polymer increases in volume; and
the void zone is sized so that the void zone can subsequently be entirely filled with the polymer after gelling of the polymer.

2. The electrochemical accumulator of claim 1, in which the leak-tight device comprises at least one leak-tight frame surrounding a first part of the electrochemical cell, and the void zone surrounds a second part of the electrochemical cell.

3. The electrochemical accumulator of claim 2, in which the leak-tight device comprises a first leak-tight frame surrounding the positive electrode of the electrochemical cell and a second leak-tight frame surrounding the negative electrode of the electrochemical cell, and the void zone surrounds the separator of the electrochemical cell.

4. The electrochemical accumulator of claim 1, in which the leak-tight device comprises a leak-tight frame surrounding the positive electrode, the negative electrode and the separator of the electrochemical cell, and the void zone surrounds the leak-tight frame.

5. The electrochemical accumulator of claim 1, in which the space further comprises a sealing frame surrounding the leak-tight device and the void zone.

6. The electrochemical accumulator of claim 1, in which the polymer is a poly(ethylene oxide), a polyacrylonitrile, a poly(vinylidene fluoride), a poly(vinylidene fluoride-co-hexafluoropropylene), a poly(vinyl chloride), a poly(vinylidene carbonate), poly(p-phenylene terephthalamide), a polyvinylsulfone, a polyvinylpyrrolidone, a poly(methylmethacrylate) or ethylene glycol dimethacrylate.

7. The electrochemical accumulator of claim 6, in which the polymer is a poly(ethylene oxide), a polyacrylonitrile, a poly(vinylidene fluoride) or a poly(vinylidene fluoride-co-hexafluoropropylene).

8. A Lithium-ion electrochemical accumulator of bipolar architecture comprising in a casing two end current collectors between which a stack is arranged along an axis X of n electrochemical cells, n being an integer of at least 2, in which:
each electrochemical cell comprises a positive electrode, a negative electrode and a separator, the separator being intercalated between the positive electrode and the negative electrode and being impregnated with a liquid electrolyte comprising a lithium salt in solution in an organic solvent;
the n electrochemical cells are separated from one another by n−1 bipolar current collectors;
the casing delimits n spaces with the two end current collectors, the n−1 bipolar current collectors and the n electrochemical cells, each space of the n spaces surrounding an electrochemical cell and comprising a leak-tight device and a void zone;
the leak-tight device of each space of the n spaces comprises a polymer that gels in contact with the solvent of the electrolyte, whereby the polymer increases in volume; and
the void zone of each space of the n spaces is sized so that the void zone of each space of the n spaces can subsequently be entirely filled with the polymer after gelling of the polymer.

9. The electrochemical accumulator of claim 8, in which the leak-tight device of each space of the n spaces comprises at least one leak-tight frame surrounding a first part of the electrochemical cell surrounded by the space, and the void zone surrounds a second part of the electrochemical cell surrounded by the space.

10. The electrochemical accumulator of claim 9, in which the leak-tight device comprises a first leak-tight frame surrounding the positive electrode of the electrochemical cell and a second leak-tight frame surrounding the negative electrode of the electrochemical cell, and the void zone surrounds the separator of the electrochemical cell.

11. The electrochemical accumulator of claim 8, in which the leak-tight device of each space of the n spaces comprises a leak-tight frame surrounding the positive electrode, the negative electrode and the separator of the electrochemical cell surrounded by the space, and the void zone surrounds the leak-tight frame.

12. The electrochemical accumulator of claim 8, in which the n−1 bipolar current collectors extend from axis X outwardly from the accumulator, in line with the two end current collectors.

13. The electrochemical accumulator of claim 12, in which each space of the n spaces comprises a sealing frame surrounding the leak-tight device and the void zone of the space.

14. The electrochemical accumulator of claim 8, in which the n−1 bipolar current collectors extend from the axis X outwardly from the accumulator, short of the two end current collectors.

15. The electrochemical accumulator of claim 14, which comprises a sealing frame extending from one end current collector to the other end current collector and surrounding the n spaces and n−1 bipolar current collectors.

16. The electrochemical accumulator of claim 8, in which the polymer is a poly(ethylene oxide), a polyacrylonitrile, a poly(vinylidene fluoride), a poly(vinylidene fluoride-co-hexafluoropropylene), a poly(vinyl chloride), a poly(vinylidene carbonate), a poly(p-phenylene terephthalamide), a polyvinylsulfone, a polyvinylpyrrolidone, a poly(methylmethacrylate) or an ethylene glycol dimethacrylate.

17. The electrochemical accumulator of claim 16, in which the polymer is a poly(ethylene oxide), a polyacrylonitrile, a poly(vinylidene fluoride) or a poly(vinylidene fluoride-co-hexafluoropropylene).
